(19) United States
(12) Patent Application Publication
(10) Pub. No.: US 2010/0198891 A1
(43) Pub. Date: Aug. 5, 2010

(54) Method and Apparatus for Base-Lining a Calculator

(75) Inventor: Matthew J Rea, St. Louis, MO (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORORATED, Dallas, TX (US)

(21) Appl. No.: 12/366,090

(22) Filed: Feb. 5, 2009

(51) Int. Cl. G06F 15/04; G06F 15/177

(52) U.S. Cl. 708/130; 709/220

(57) ABSTRACT

A method and apparatus for base-lining a calculator, wherein said base-lining configures a calculator to a known configuration. The method includes connecting a calculator to a calculator network, determining the configuration desired for a calculator, and base-lining a calculator, wherein said calculator is configured according to the determined configuration desired.

### BACKGROUND OF THE INVENTION

1. Field of the Invention

Embodiments of the present invention generally relate to a method and apparatus for base-lining a calculator to a desired configuration.

2. Description of the Related Art

In a classroom, teachers utilize calculators for teaching mathematics, finance, geometry and sciences. In many occasions, a teacher has to demonstrate the use of various functions and key sequences. However, calculators can be set to various modes. Function and various keys change depending on the mode the calculator is set to. As a result, in order to properly teach the students, the teacher has to address each student to ensure that the student is utilizing the calculator in the proper mode and configuration.

Therefore, there is a need for a method and/or apparatus for base-lining calculators to a known configurations or mode.

### SUMMARY OF THE INVENTION

Embodiments of the present invention relate to a method and apparatus for base-lining a calculator, wherein said base-lining configures a calculator to a known configuration. The method includes connecting a calculator to a calculator network, determining the configuration desired for a calculator, and base-lining a calculator, wherein said calculator is configured according to the determined configuration desired

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a front view of a calculator;

FIG. 2 is an embodiment of a block diagram of a system for base-lining a calculator;

FIG. 3 is an embodiment of a classroom calculator network;

FIG. 4 is a flow diagram depicting an embodiment of a system method for base-lining a calculator; and

FIG. 5 is a flow diagram depicting an embodiment of a calculator method for base-lining the calculator.

### DETAILED DESCRIPTION

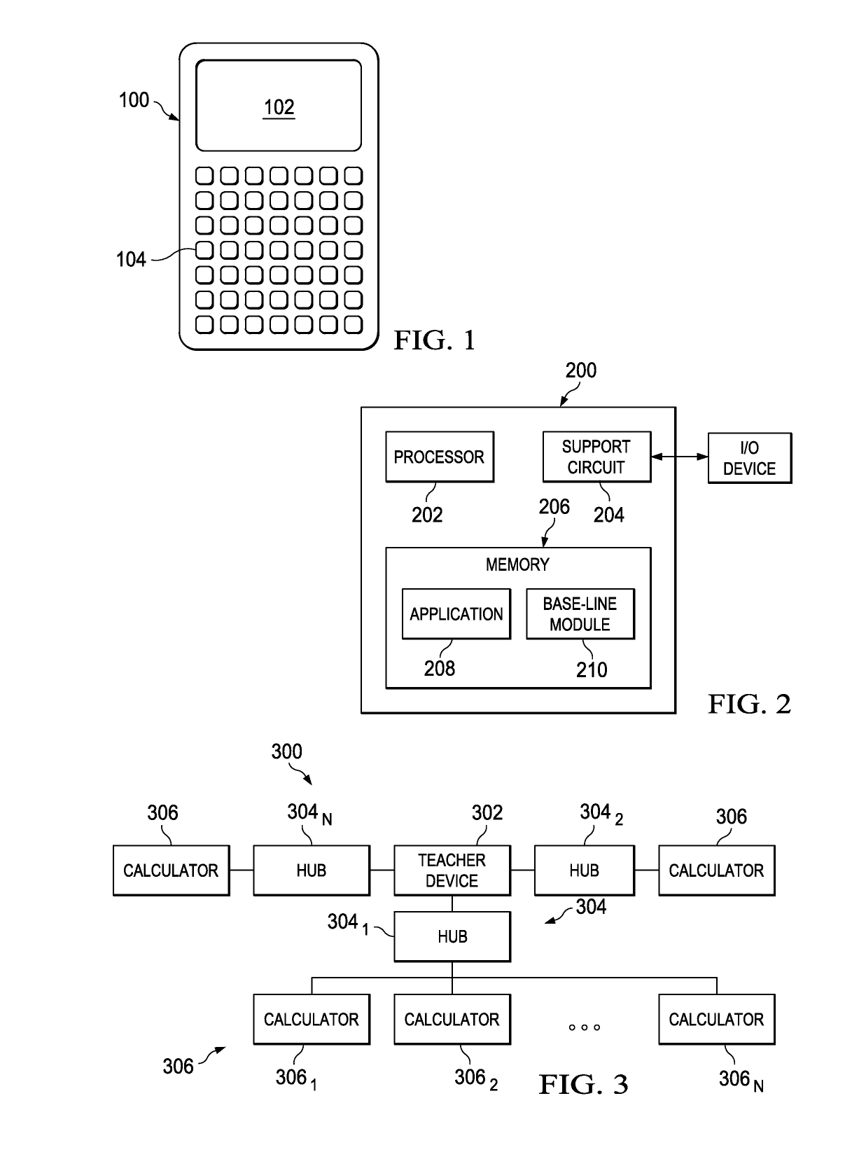

FIG. 1 is an embodiment of a front view of a calculator 100. The calculator 100 includes a display screen 102 and an input device 104. The calculator 100 is well known in the art and is utilized in a classroom, for example, for performing calculations related to geometry, algebra, science and/or finance. The calculator 100 may be also coupled or may include an output device and other modules or devices, such as, audio, video, graphical, printer and/or LED display.

The display screen 102 displays input data and generated results or messages. The display screen 102 may be an LCD screen, a calculator screen, a monitor or any display that may be utilized by the calculator 100. The input device 104 may be a keypad, an interactive whiteboard, a touch screen or any device that provides data to the apparatus 100. The input device 104 allows a user to enter data to the calculator 100. The display screen or the input device may be included within or coupled to the calculator 100.

FIG. 2 is an embodiment of a block diagram of a system 200 for base-lining a calculator. The system 200 includes a processor 202, support circuit 204 and memory 206.

The processor 202 may comprise one or more conventionally available microprocessors. The microprocessor may be an application specific integrated circuit (ASIC). The support circuits 204 are well known circuits used to promote functionality of the processor 202. Such circuits include, but are not limited to, cache, power supplies, clock circuits, input/output (I/O) circuits and the like. The memory 204 may comprise random access memory, read only memory, removable disk memory, flash memory, and various combinations of these types of memory. The memory 204 is sometimes referred to as main memory and may, in part, be used as cache memory or buffer memory. The memory 204 may store an operating system (OS), database software, various forms of application software, such as, applications 208 and pictorial algebraic module 210, and the like. It should be noted that a computer readable medium is any medium utilized by a computer system for storing and/or retrieving data.

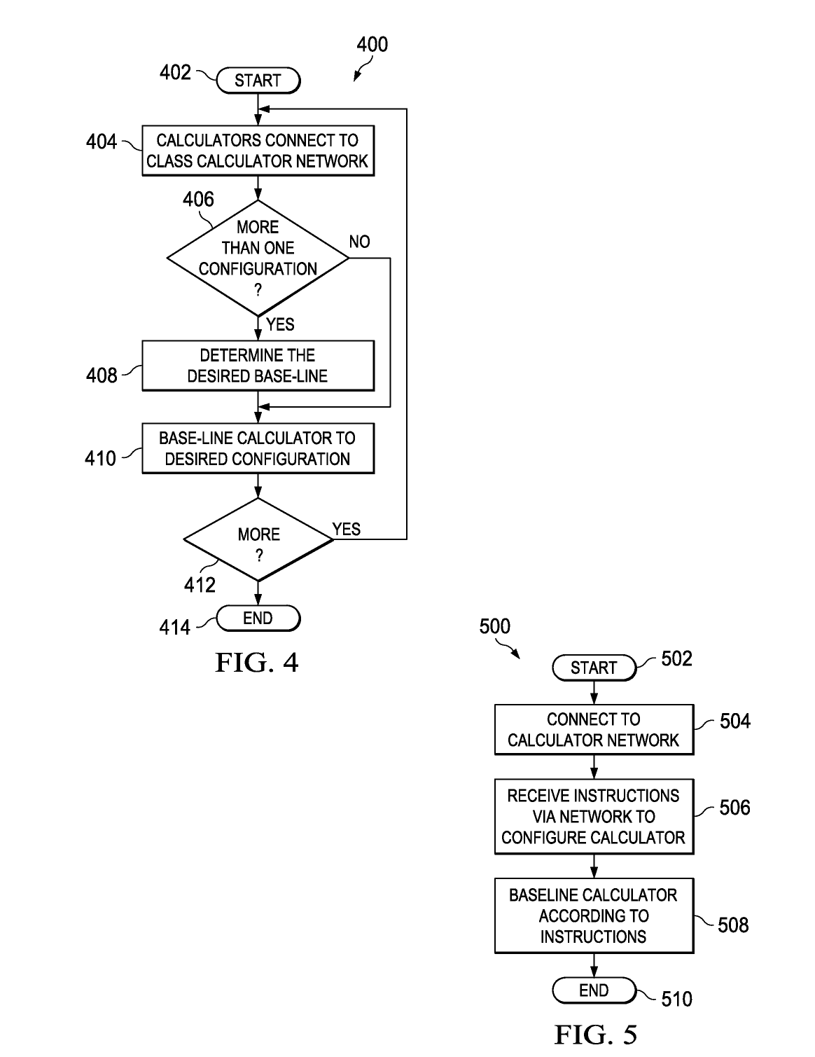

The applications 208 may include any applications utilized by the system 200 or calculator 100. The applications 208 may include graphic and/or algebraic applications. The base-lining module 210 is utilized to base-line calculator on a calculator network to a desired configuration. The base-lining module 210 facilitates system method and performs the calculator method described in FIG. 4 and FIG. 5.

FIG. 3 is an embodiment of a classroom calculator network 300. The classroom calculator network 300 may be utilized by a teacher in a classroom to base-line calculators on the calculator network 300. A calculator network is similar to a classroom calculator network but is utilized outside the classroom. The classroom calculator network 300 includes a teacher device 302, a hub 304, shown as 304₁, 304₂ . . . 304_{N}, and calculator 306, shown to include calculators 306₁, 306₂ . . . 306_{N}. The classroom calculator network may include any number of teacher devices 302, hub 304 and/or calculators 306. The teacher device 304, hub 304 and calculator 306 may communicate wirelessly, via Ethernet, port cables, combination thereof and the like.

The teacher device 302 is utilized by a teacher to select calculators, configurations, hubs, functionalities, and the like for the base-lining. The teacher device 302 may be a computer, laptop or a calculator setup to initialize the base-lining, configuring, selecting calculators and/or hubs, and the like. For example, a teacher may utilize the teacher device 302 to select finance mode to all calculators on hub 304₁ and to remove all files that were downloaded to the calculator 306 prior to the teacher base-lining the calculator. The teacher may also load an exam file as part of a configuration to all calculators on hub 304_{N} and to calculator 306₂ on hub 304₁. The calculators 306 may also be automatically base-lined to a specific configuration, including deleting and adding files, once the calculators connect to the classroom calculator network. A teacher may wish to change the desired configuration according to a time, date, date/time and the like. For example, the teacher may not delete pre-existing files as part of a base-line for the Monday 8 am class, but may wish to delete pre-existing files and add an exam file for the same class on Wednesdays, when a quiz is scheduled. Accordingly, the teacher may teach a class or conduct an exam with all the calculators on the classroom calculator network base-lined to a known configuration of the teacher's choice.

FIG. 4 is a flow diagram depicting an embodiment of a method 400 for base-lining a calculator. The method 400 starts at step 402 and proceeds to step 404. At step 404, a calculator connects to a class calculator network (shown in FIG. 3). At step 406, the method 400 determined if there is more than one configuration. If there is more than one configuration, the method 400 proceeds from step 406 to step 408. At step 408, the method 400 determines which configuration is desired for base-lining the calculator and the method proceeds to step 410. If there is one configuration, the method 400 proceeds from step 406 to step 410. At step 410, the calculator is base-lined to the desired configuration. At step 412, the method 400 determines if there are more calculators to base-line. If there are more calculators to base-line, the method 400 proceeds to step 404. Otherwise, the method 400 ends at step 414.

The method 400 may configure multiple calculators simultaneously. In addition, the method 400 may be initialized by simply connecting to a calculator network or by a user request that triggers the method 400 to initialize one or more calculator. The method 400 may contain any number of available configurations. As such, a user may select the appropriate configuration for a calculator or may setup a default configuration for a calculator or a network.

FIG. 5 is a flow diagram depicting an embodiment of a calculator method 500 for base-lining the calculator. The method 500 starts at step 502 and proceeds to step 504. At step 504, the calculator connects to a calculator network. At step 506, the calculator receives instructions via the calculator network outlining configuration setting, such as, delete data, add data, change mode, change setting, change functionality and the like. At step 508, the method 500 base-lines the calculator according to the instructions received via the calculator network. The method 500 ends at step 510.

While the foregoing is directed to embodiments of the present invention, other and further embodiments of the invention may be devised without departing from the basic scope thereof, and the scope thereof is determined by the claims that follow.

What is claimed is:

1. A method for base-lining a calculator, wherein said base-lining configures a calculator to a known configuration, the method comprising:
connecting a calculator to a calculator network;
determining the configuration desired for a calculator; and
base-lining a calculator, wherein said calculator is configured according to the determined configuration desired.

2. The method of claim 1, wherein the calculator network is a classroom calculator network.

3. The method of claim 1 further comprising determining the desired configuration according to at least one of a calculator network hub, a specific calculator, or a date or time.

4. The method of claim 1, wherein the method is executed when the calculator connects to the calculator network.

5. A calculator capable of being base-lined, wherein said base-lining configures a calculator to a known configuration, the method comprising:
means for connecting a calculator to a calculator network;
means for receiving instruction via the calculator network for configuring the calculator; and
means for base-lining the calculator according to the instructions.

6. The calculator of claim 5, wherein the calculator network is a classroom calculator network.

7. The calculator of claim 5, wherein the base-lining causes the calculator to at least one of delete data, add data, change configuration or change a functionality.

8. A computer readable medium comprising software that, when executed by a processor, causes the processor to perform a method for base-lining a calculator, the method comprising:
connecting to a calculator network;
receiving instruction via the calculator network for configuring the calculator; and
base-lining the calculator according to the instructions.

9. The computer readable medium of claim 8, wherein the calculator network is a classroom calculator network.

10. The computer readable medium of claim 8, wherein the base-lining causes the calculator to at least one of delete data, add data, change configuration, change a setting, or change a functionality.
